(19) United States
(12) Patent Application Publication
(10) Pub. No.: US 2015/0188117 A1
(43) Pub. Date: Jul. 2, 2015

(54) BATTERY TERMINAL FOR VEHICLE

(71) Applicants: Jeong Sun You, (US); Hyundai Motor Company, Seoul (KR); Yura Corporation Co., Ltd, Cheongwon (KR)

(72) Inventors: In Sic Kim, Suwon (KR); Jeong Sun You, Cheonan (KR); Dong Hyun Kim, Hwaseong (KR)

(21) Appl. No.: 14/560,118

(22) Filed: Dec. 4, 2014

(30) Foreign Application Priority Data
Dec. 27, 2013 (KR) 10-2013-0165322

(51) Int. Cl. H01M 2/30; H01R 4/38

(52) U.S. Cl. CPC H01M 2/305; H01R 4/38; H01M 2220/20

(57) ABSTRACT

A battery terminal for a vehicle is provided which is prevented from being separated from a battery post by increasing rotation holding force and cross holding force of a pressing portion that presses a battery post, prevents a battery post from being damaged in fastening, and is more easily separated when a battery is replaced. The battery terminal includes a pressing portion configured to press the outer side of a battery post. A clamping portion includes a pair of elastic clamping members integrally extending from both ends of the pressing portion and to which a clamping bolt and a clamping nut are fastened through fastening apertures of the elastic clamping members. A burring protrudes toward the first elastic clamping member and is formed around a fastening aperture of the second elastic clamping member facing the first elastic clamping member of the pair of elastic clamping members.

### CROSS-REFERENCE TO RELATED APPLICATION

This application claims under 35 U.S.C. §119(a) the benefit of Korean Patent

Application 10-2013-0165322 filed Dec. 27, 2013, the entire contents of which are incorporated herein by reference.

### BACKGROUND

(a) Technical Field

The present invention relates to a battery terminal for a vehicle, and more particularly, to a battery terminal for a vehicle that increases rotation holding force and cross holding force of a pressing portion that presses a battery post to improve restoring force of a clamping portion where a clamping bolt and a clamping nut are secured, and to minimize cracks.

(b) Background Art

As well known in the art, vehicles include a battery that supplies power to electric devices within the vehicles such as a start motor, a light system, and a multimedia system. Vehicle batteries, generally provided in the form of a chargeable/dischargeable secondary battery, are configured to store power from a power generator in charging and discharge by supplying power to electric devices connected via cables. Battery terminals for connection with positive (+) and negative (−) battery posts are used to connect these batteries. The power of a battery is supplied to electric devices such as a start motor via a battery terminal made of a conductive material and cables by connecting the cables connected to the battery terminal, to the electric devices, with the battery terminal fixed and electrically connected to the battery posts.

Since the vehicle batteries are not a permanent part but a consumable part within a vehicle, the amount of charge decreases as the age of the battery increases, and as a result, the amount of electric energy stored in the batteries decreases below a predetermined level required for vehicles; thus requiring replacement. Since vehicle batteries are usually disposed in relatively small locations within the vehicle due to the layout within a vehicle body, a tool for mounting (e.g., fastening) the battery terminal to the positive (+) and negative (−) posts is interfered with the devices in vehicles, thus making the mounting work more difficult. The difficulty stems from a nut 120 and a bolt 110 horizontally disposed through a side of a battery terminal 100, as shown in FIG. 1, being are required to be tightened and loosened to fasten/separate a battery terminal to/from a battery post.

In addition, using the side-fastening type battery terminal 100 requires handling a tool from a side angle to tighten or loosen the bolt 110 and the nut 120, such that the tool is interfered with various internal parts. Accordingly, battery terminals have been developed with an inclined clamping portion to allow for more easily tightening and loosening of a nut from a side when fastening the battery terminal to a battery post.

According to the developed battery terminals of the related art, the areas that are stably seated on a battery post are substantially small and the areas that can maintain the force applied when a nut is tightened or loosened is also substantially small, causing the battery terminals to be distorted in the direction of the force. As a result, poor contact with a battery post and breakage of the battery terminals may occur.

Further, in the existing battery terminals of the related art, the restoring force of the portions that are tightened by a bolt and a nut may decrease due for example, fastening for an extensive period of time, the material and thickness of the battery terminals, and the force applied in assembling and the portions may stick together. Accordingly, it may be difficult to separate the battery terminals from a battery post requiring the battery post to be replaced or removed. In addition, since battery posts are usually made of lead which is a substantially soft material lacking elasticity, battery terminals may be naturally separated in used, thus causing difficulty in bringing the battery terminals in contact with battery posts. Therefore, the batteries may be damaged and the lifespan may decrease.

The above information disclosed in this section is merely for enhancement of understanding of the background of the invention and therefore it may contain information that does not form the prior art that is already known in this country to a person of ordinary skill in the art.

### SUMMARY

The present invention provides a battery terminal for a vehicle which may be prevented from being separated from a battery post by increasing rotation holding force and cross holding force of a pressing portion that presses a battery post, may prevent a battery post from being damaged in fastening, and may be more easily separated when a battery is replaced. Further, the present invention provides a battery terminal for a vehicle which may minimize deformation of the clamping portion where a clamping bolt and a clamping nut are tightened, improve restoring force of the clamping portion, and minimize cracks.

In order to achieve the object, the present invention provides a battery terminal for a vehicle which may include: a pressing portion that presses (e.g., exerts force onto) an outer side of a battery post; and a clamping portion having a pair of elastic clamping members integrally extending from both ends of the pressing portion and to which a clamping bolt and a clamping nut may be fastened via fastening apertures of the elastic clamping members, in which a burring that protrudes toward the first elastic clamping member may be formed around the fastening aperture of the second elastic clamping member facing the first elastic clamping member of the pair of elastic clamping members.

On the inner side of the burring (e.g., a burr), a tapered portion of which the inner diameter gradually decreases from the end of the burring may be formed at the end portion from which the clamping bolt is inserted, to prevent the threads of the clamping bolt from being locked and interfered. The surfaces of the parts of the terminal which include the clamping portion and the pressing portion may be plated with a silicon-zinc (Sn—Zn) alloy and then chromate treatment may be performed on the surfaces as a surface treatment to prevent corrosion and cracks caused by stress. The first elastic clamping member may be the elastic clamping member where the clamping bolt may be inserted and the second elastic clamping member may be the elastic clamping member where the clamping nut may be fastened.

A first wing that bends toward the head of the clamping bolt may be formed along a side of the first elastic clamping member to restrict rotation of the clamping bolt. A second wing that bends along the side opposite to the first wing may be formed at the first elastic clamping member to prevent deformation of the clamping portion. A third wing that bends toward the second elastic clamping member along the end of the first elastic clamping member may be formed to maintain the gap between the first elastic clamping member and the second elastic clamping member, when coming in contact with the corresponding portion of the end of the second elastic clamping member. Additionally, fourth wings that bend to restrict the rotation of a washer between the clamping nut and the second elastic clamping member may be formed along both sides of the second elastic clamping member. Long protrusions or serration grooves may be formed circumferentially around the inner side of the pressing portion.

According to the battery terminal for a vehicle of the present invention, since the burring and the wings may be formed on the elastic clamping members of the clamping portion where the clamping bolt and the clamping nut are fastened, it may be possible to maximize the rotation holding force and the cross holding force of the terminal, improve restoring force of the clamping portion, and minimize cracks.

Further, it may be possible to prevent the terminal from separating from a battery post and to prevent poor contact between the terminal and the battery post by maximizing the rotation holding force and the cross holding force, it may be possible to prevent the battery post from being damaged when fastening the terminal, and it may be possible to more easily separate the battery terminal when replacing a battery, by preventing the first elastic clamping member and the second elastic clamping member from sticking together. Additionally, it may be possible to minimize corrosion and stress due to oxygen, carbonic acid gas, and moisture etc. in the air and to effectively prevent cracks in the terminal due to corrosion and stress by plating the surface of the terminal with a Sn—Zn alloy and then performing chromate treatment as surface treatment.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary view showing a battery terminal according to the related art;

FIG. 2 is an exemplary view of a battery terminal for a vehicle according to an exemplary embodiment of the present invention;

FIG. 3 is an exemplary plan view of the battery terminal for a vehicle according to an exemplary embodiment of the present invention;

FIG. 4 is an exemplary side view of the battery terminal for a vehicle according to an exemplary embodiment of the present invention;

FIG. 5 is an exemplary enlarged view showing the clamping portion of the battery terminal for a vehicle according to an exemplary embodiment of the present invention;

FIG. 6 is an exemplary enlarged view showing the pressing portion, the clamping portion, and a serration groove of the battery terminal for a vehicle according to an exemplary embodiment of the present invention;

FIGS. 7 and 8 are exemplary views showing a burring in the battery terminal for a vehicle according to an exemplary embodiment of the present invention;

FIG. 9 is an exemplary view showing an assembly angle between a battery post and the battery terminal for a vehicle according to an exemplary embodiment of the present invention; and

FIG. 10 is an exemplary enlarged view showing the burring and a bending portion of an elastic clamping member in the battery terminal for a vehicle according to an exemplary embodiment of the present invention.

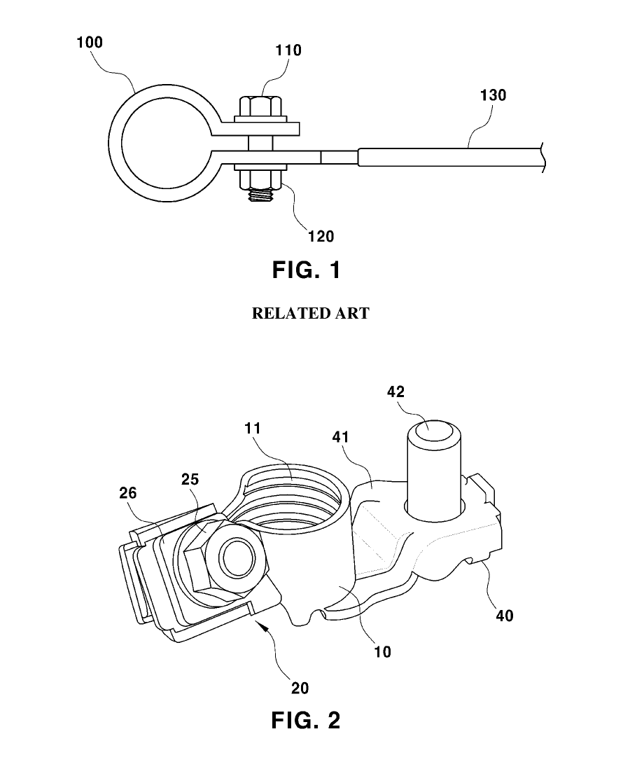

10: pressing portion

11: serration groove

14: support portion

15: battery post

20: clamping portion

21: first elastic clamping member

21a: first wing

21b: second wing

21c: third wing

22: second elastic clamping member

22a: fourth wing

23: fastening aperture

24: clamping bolt

15: clamping nut

26: washer

27: anti-rotation nose

28: burring

30: connecting portion

31: protrusion

40: cable connecting portion

41: fixing plate

42: fixing member

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the accompanying claims.

Hereinafter, the present invention will be described more fully with reference to the accompanying drawings for those skilled in the art to easily implement the present invention.

The present invention provides a battery terminal for a vehicle which may be prevented from being separated from a battery post by increasing rotation holding force and cross holding force of a pressing portion that presses a battery post, may prevent a battery post from being damaged in fastening, and may be more easily separated when a battery is replaced.

Further, the present invention provides a battery terminal for a vehicle which may minimize deformation of the clamping portion where a clamping bolt and a clamping nut are tightened, improve restoring force of the clamping portion, and minimize cracks. A battery terminal for a vehicle according to the present invention may include: a pressing portion that presses (e.g., exerts force onto) the outer side of a battery post and is coupled to the battery post; a clamping portion including a pair of elastic clamping members integrally extending from both ends of the pressing portion and disposed at an angle with respect to the pressing portion and configured to adjust the gap between the elastic clamping members with a clamping bolt and a clamping nut combined through fastening apertures of the elastic clamping members; a connecting portion including support portions integrally extending from the pressing portion to be seated on a battery; and a cable connecting portion that extends from the connecting portion and is configured to fix a cable for supplying power from a battery to the inside of a vehicle.

In this configuration, the battery terminal for a vehicle according to the present invention may further include a washer having an anti-rotation nose to prevent idling of the clamping nut and may be disposed between an elastic clamping member and the clamping nut. Further, a burring formed around the fastening aperture of a second elastic clamping portion may face a first elastic clamping member of the pair of elastic clamping members and may protrude toward the first elastic clamping member, to prevent deformation and distortion of the clamping portion in the battery terminal for a vehicle. The battery terminal for a vehicle according to the present invention is characterized by plating the parts including the clamping portion and the pressing portion with an Sn—Zn alloy and then performing chromate treatment on the parts to prevent corrosion and cracks due to stress.

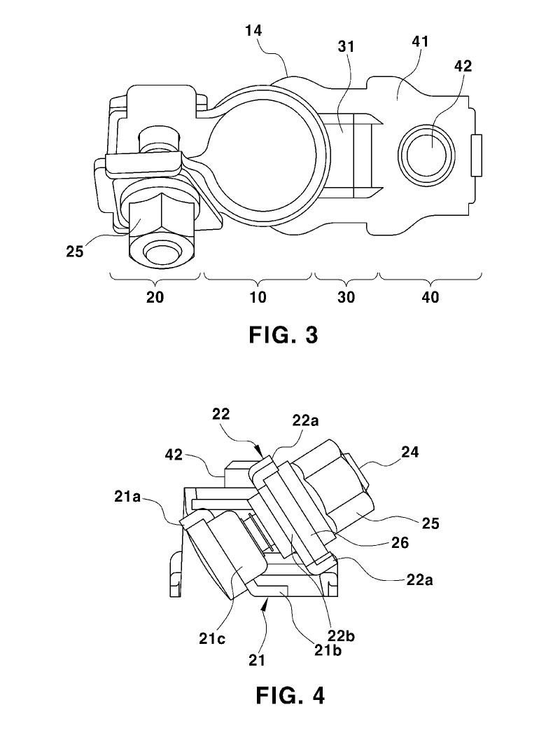

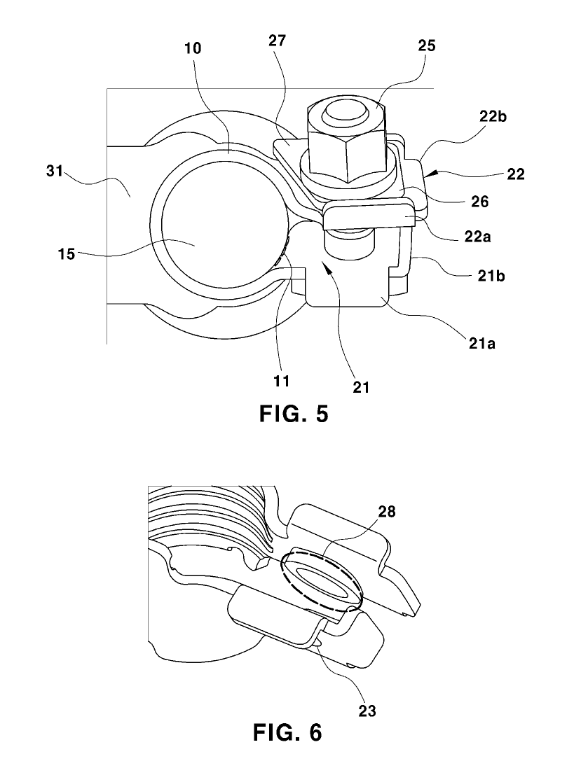

Hereinafter, exemplary embodiments of the present invention are described in detail with reference to the accompanying drawings. FIG. 2 is an exemplary perspective view of the battery terminal for a vehicle according to an exemplary embodiment the present invention and FIG. 3 is an exemplary plan view of the battery terminal for a vehicle according to an exemplary embodiment the present invention. FIG. 4 is an exemplary side view of the battery terminal for a vehicle according to an exemplary embodiment the present invention and FIG. 5 is an exemplary enlarged view showing the clamping portion of the battery terminal for a vehicle according to an exemplary embodiment the present invention. As exemplified in the figures, the battery terminal for a vehicle according to the present invention may include a pressing portion 10, a clamping portion 20, a connecting portion 30, and a cable connecting portion 40.

The pressing portion 10 may be, as shown in FIGS. 2, 3, 5, 6, and 7, formed in a substantially cylindrical shape to press (e.g., exert force onto) the outer side of a battery post 15 and may have an open side to be opened to both sides or closed by the open side. The pressing portion 10 may be configured to press (e.g., exert force onto) the outer side of the battery post 15 with the inner side of the pressing portion 10, with the ends of the open sides closer to each other by clamping force applied by the clamping portion 20 (e.g., the clamping force moves the ends closer in distance). The shape of the inside of the pressing portion 10 where the battery post 15 may be inserted may fit to (e.g., may correspond to) the outer shape of the battery post to uniformly press the outer side of the battery post. Further, the battery post 15 may be tapered such that the diameter increases in a downward direction, and the pressing portion 10 may be tapered accordingly such that the inner diameter increases downwardly.

Protrusions or serration grooves 11 may be formed around the inner side of the pressing portion 10. The protrusions or serration grooves 11 may be elongated circumferentially (e.g., horizontally in the figures) around the inner side of the pressing portion 10. The protrusions or the serration grooves 11 may be formed in any shape as long as they may be held inside the battery post, when the battery post is inserted into the pressing portion 10. The protrusions or serration grooves 11, which may prevent the pressing portion 10 pressing the battery post 15 from separating from the battery post or rotating, may increase holding force (e.g., cross holding force preventing axial separation and rotation holding force preventing rotation) of the pressing portion by increasing the contact area between the pressing portion and the battery post when the inner side of the pressing portion 10 presses the outer side of the battery post 15.

As is known in the art, since the battery post 15 is conventionally made of soft lead, when the inner side of the pressing portion 10 presses the outer side of the battery post 15, the outer side of the battery post may be deformed at the portions in contact with the serration grooves 11, in which the deformed portions of the outer side of the battery post are inserted and fitted in the serration grooves (e.g., the deformed portions of the surface of the battery post are held in the grooves). Accordingly, the contact area between the pressing portion 10 and the battery post 15 may be increased and the holding force that maintains the entire terminal from moving may be increased. In this configuration, the pressing force 10 presses the battery post 15 by the clamping force of the clamping bolt 24 and the clamping nut 25 in the fastening apertures 23 of the clamping portion 20 extending integrally from both ends of the pressing portion 10.

The clamping portion 20 may include a pair of elastic clamping members 21 and 22 integrally extending in plate shapes from both ends of the pressing portion 10, at an angle with respect to the pressing portion 10, and the fastening apertures 23 through which the clamping bolt 24 is inserted may be formed at the elastic clamping members 21 and 22. The clamping bolt 24 and the clamping nut 25 may be fastened through the fastening apertures 23 of the elastic clamping members 21 and 22 and may be configured to adjust the gap between the elastic clamping members, particularly tighten the elastic clamping members 21 and 22, such that the clamping force enables the pressing portion 10 to press the battery post 15.

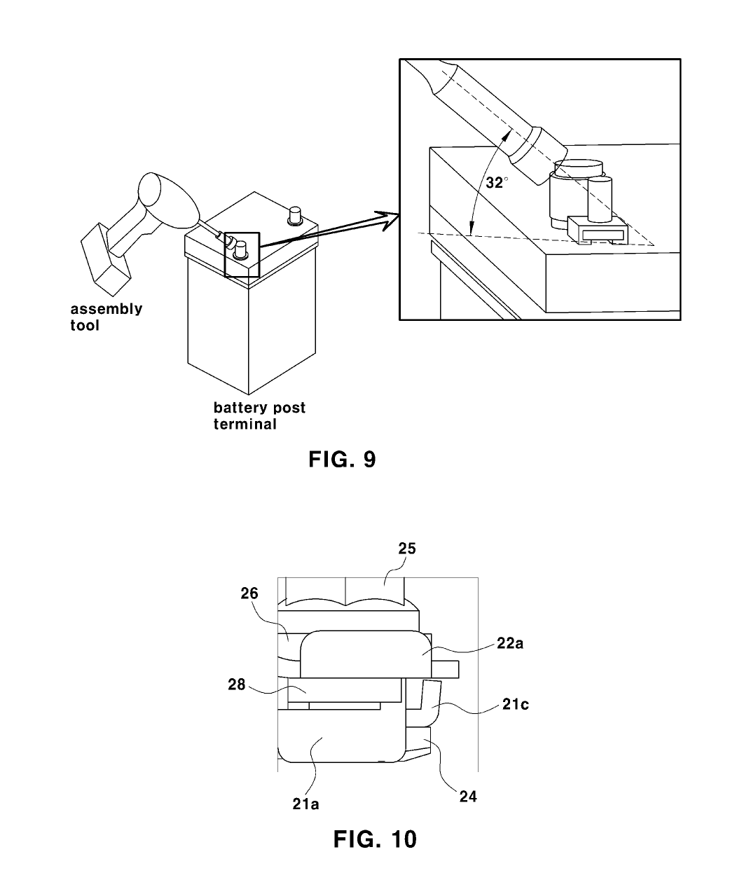

The elastic clamping members 21 and 22 of the clamping portion 20 may be inclined at about 30°˜45° with respect to the horizon to allow the clamping nut 25 to be more easily tightened or loosened from a side direction. Additionally, the elastic clamping members 21 and 22 may be inclined at about 32° with respect to the horizon (see FIG. 9). When the elastic clamping members 21 and 22 are inclined at an angle of less than about 30° or greater than about 45°, a battery terminal may be separated and not stably seated on the battery post 15 by the direction of the force applied in assembling, causing difficulty in stably fastening the battery terminal and the battery post. When the elastic clamping members 21 and 22 of the clamping portion 20 are formed in the plate shapes inclined at a predetermined angle from the pressing portion 10, as described above, fastening the clamping nut 25 becomes more convenient.

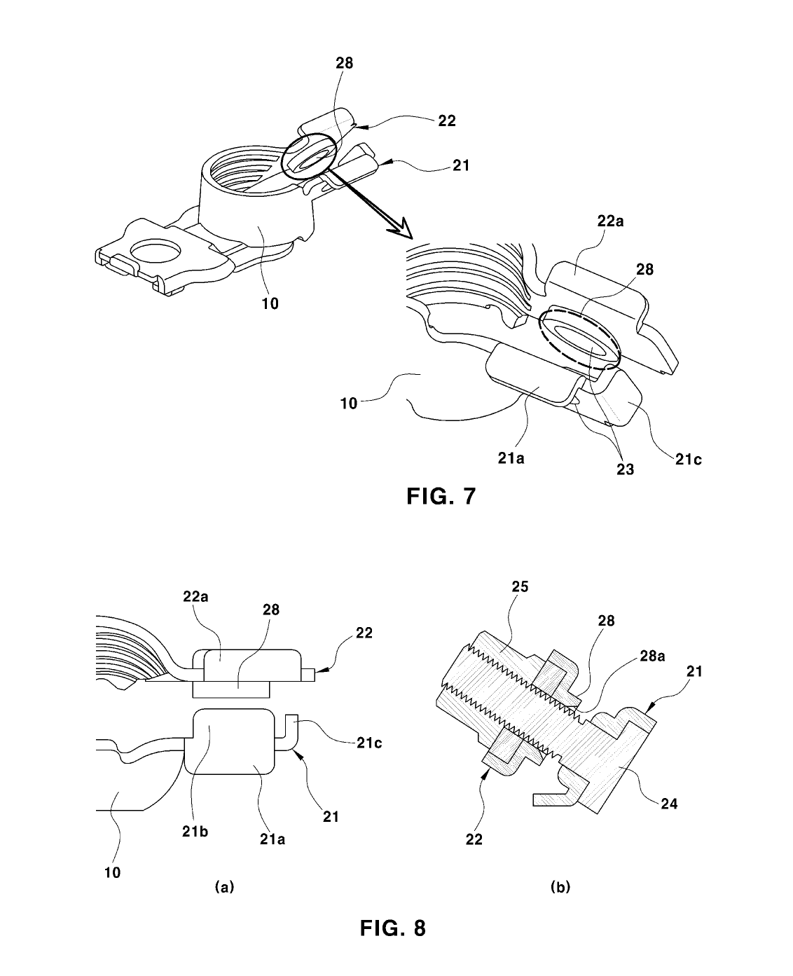

The elastic clamping members 21 and 22 may be the first elastic clamping member 21 where the head of the clamping bolt 24 is seated and the second elastic clamping member 22 where the clamping nut 25 is seated. As shown in FIGS. 7 and 8, a first wing 21a that bends toward the head of the clamping bolt may be formed along the side of the first elastic clamping member 21 to restrict rotation of the clamping bolt 24. A second wing 21b may be formed along the side opposite to the first wing of the first elastic clamping member 21 and a third wing 21c that bends toward the second elastic clamping member may be formed along the end of the first elastic clamping member 21. The second and third wings may prevent the first elastic clamping member 21 from being deformed and distorted and from separating from the battery seat in clamping and reinforce the structure of the clamping portion 20, in cooperation with the first wing 21a.

In particular, the third wing 21c at the end of the first elastic clamping member 21 may operate as a stopper configured to prevent deformation of the battery post 15 by coming in contact with (e.g., touching, connecting with, etc.) the corresponding portion of the end of the second elastic clamping member 22, in clamping with excessive force (e.g., force greater than a predetermined force). In other words, the first elastic clamping member 21 and the second elastic clamping member 22 may be moved to reduce the gap therebetween, in bolt-nut fastening, and thus when an excessive torque (e.g., a torque greater than a predetermined torque) is applied in bolt-nut fastening, the battery post 15 may be substantially deformed. Accordingly, the third wing 21c that functions as a stopper may be formed at the end of any one of both elastic clamping members 21 and 22 to prevent the deformation.

As described above, excessive torque may not be applied in bolt-nut fastening by the third wing 21c. When the clamping nut 25 is tightened to a predetermined level, the third wing 21c may come into contact with the opposite elastic clamping member and the gap between the elastic clamping members 21 and 22 may be maintained at a predetermined level by the contact. As the gap is maintained, it may be possible to prevent excessive torque and fastening force from being applied in bolt-nut fastening and the pressing portion 10 may be prevented from excessively pressing (e.g., applying force greater than a predetermined force) the battery post 15 due to the clamping force from the elastic clamping members 21 and 22, to prevent at deformation of the battery post.

Further, since the elastic clamping members 21 and 22 may not be brought in direct surface contact and the end of the third wing 21c may come into contact, the restoring force of the elastic clamping members 21 and 22 may be maintained in fastening with excessive torque and the terminal, including the elastic clamping members 21 and 22, may be prevented from deforming in fastening with excessive torque. Accordingly, it may be possible to prevent the terminal from losing or separating due to deformation.

Moreover, fourth wings 22a may be formed along both sides of the second elastic clamping member 22 to prevent the washer 26 from rotating by locking the anti-rotation nose 27 of the washer 26 between the second elastic clamping member 22 and the clamping nut 25. Further, a circular burring 28 may protrude around the fastening aperture 23 of the second elastic clamping member 22, toward the first elastic clamping member 21 facing the second elastic clamping member 22.

In an exemplary embodiment, since the first elastic clamping member 21 is the elastic clamping member where the clamping bolt 24 is inserted and the second elastic clamping member 22 is the elastic clamping member where the clamping nut 25 is fastened, the burring 28 may be formed on the second elastic clamping member 22 where the clamping nut 25 is fastened. In addition, the burring may be formed around the fastening aperture of the first elastic clamping member, instead of the second elastic clamping member. Basically, the fourth wings 22a and the burring 28 may prevent the second elastic clamping member 21 from being deformed and distorted and separating and reinforce the structure of the clamping portion 20. In particular, the burring 28 may be configured to function as a stopper that maintains the gap between the first elastic clamping member 21 and the second elastic clamping member 22, such that it may be possible to minimize deformation of the elastic clamping members 21 and 22 and the fastening apertures 23 and prevent excessive torque from being applied.

When the burring 28 is provided, as described above, deformation of the clamping portion 20 by the fastening apertures 23 pushed may be minimized, and the terminal may be prevented accordingly from bending. Accordingly, the terminal may be more stably seated on the battery seat without being separately therefrom. Further, the burring 28, as shown in FIGS. 4 to 10, may not be in contact with (e.g., may be separated from) the first elastic clamping member 21, but may function as a stopper by contacting the first elastic clamping member 21 in fastening with excessive torque. Accordingly, the burring 28 may be configured to prevent the first elastic clamping member 21 and the second elastic clamping member 22 from sticking together (e.g., sticking may be further prevented, as compared with the surface contact between elastic clamping members in the related art), even when the burring 28 is used for a substantial time period in contact with the first elastic clamping member 21, such that the battery terminal may be more easily separated from the post 15, when the battery is replaced. This is the same for the third wing 21c that may be configured to function as a stopper in the first elastic clamping member 21.

Furthermore, the rotation holding force (e.g., the force holding the terminal in the rotational direction) and the cross holding force (e.g., the force holding the terminal in the axial direction of the battery post), which are mechanical properties of the pressing portion 10, and the restoring force of the clamping portion 20 and the terminal may be increased. In addition, it may be possible to prevent bad start (e.g., a start failure) caused by movement of the terminal due to incomplete fastening. In other words, the wings 21a, 21b, 22c, and 22a and the burring 28 of the first elastic clamping member 21 and the second elastic clamping member 22 may function as reinforcing members configured to prevent deformation and breakage of the clamping portion 20 by distributing the load due to bolt-nut tightening.

Moreover, on the inner side of the burring 28, a tapered portion 28a of which the inner diameter decreases downward from the end of the burring may be formed at the end portion from which the clamping bolt 24 is inserted, as shown in FIG. 9. The tapered portion 28a may be configured to prevent the threads of the clamping bolt 24 from being locked and interfered with the outer end of the burring 28, when the clamping bolt 24 is inserted into the fastening aperture 23 of the second elastic clamping member 22 in the inclined fastening type, such that the clamping bolt 24 may be more smoothly inserted into the burring without the threads interfered. Accordingly, damage to the threads of the clamping bolt 24 may be prevented and the clamping ability of the clamping bolt 24 may be improved, by the tapered portion 28a.

The washer 26 may include the anti-rotation nose 27 at a side and the washer 26 may be disposed between the second elastic clamping member 22 and the clamping nut. Since the washer 26 may not rotate when the anti-rotation nose 27 is locked to the fourth wings 22a of the second elastic clamping member 22, the clamping nut 25 may not idle in tightening and the fastening force between the clamping nut 25 and the clamping bolt 24 may be improved, and accordingly they may be prevented from loosening.

The reference numeral ‘14’ in FIG. 13 indicates support portions integrally formed in wing shapes at a bottom of the pressing portion 10 and the pressing portion 10 may be arranged horizontally on a battery by the support portions 14. The support portions 14 may allow the pressing portion 10 to more stably receive clamping force from the clamping portion 20 and contribute to improving the holding force and restoring force of the terminal. The connecting portion 30 may be the portion that connects the pressing portion 10 and the cable connecting portion 40, and the support portions 13 and the connecting portion 30 may have substantially large areas brought in contact with the top of the battery post 15, to cause the battery terminal to be more stably seated on the top of the battery post. Further, force may be applied to the substantially large contact area of the connecting portion when the terminal is fastened to the battery post 15, to more firmly fasten the battery terminal to the battery post.

A protrusion 31 may be formed on the connecting portion 30 by beading, since the connecting portion 31 may be structurally weak, such that the terminal may be prevented from being distorted and broken by the protrusion 31, when the clamping portion 30 is fastened. The cable connecting portion 40, which is a part where a cable (not shown) for supplying power from a battery to the inside of a vehicle is connected and fixed, may include a fixing plate 41 formed in a plate shape and having a fastening aperture (not shown) and a fixing member 42 inserted into the fastening aperture of the fixing plate 41.

The configuration of the battery terminal according to an exemplary embodiment of the present invention was described in detail above and the surface of the battery terminal may be plated with a Sn—Zn alloy and then perform chromate treated to prevent corrosion and cracks due to stress. It may be possible to minimize corrosion and stress due to external factors such as oxygen, carbonic acid gas, and moisture in the air and to effectively prevent cracks in the terminal due to corrosion and stress by forming the terminal of brass, plating the surface with a Sn—Zn alloy, and then performing chromate treatment as surface treatment.

Although exemplary embodiments of the present invention were described in detail above, the scope of the present invention is not limited to the exemplary embodiments and various changes and modifications from the spirit of the present invention defined in the following claims by those skilled in the art are also included in the scope of the present invention. The invention has been described in detail with reference to exemplary embodiments thereof. However, it will be appreciated by those skilled in the art that changes may be made in these exemplary embodiments without departing from the principles and spirit of the invention, the scope of which is defined in the accompanying claims and their equivalents.

What is claimed is:

1. A battery terminal for a vehicle comprising:
a pressing portion configured to press the outer side of a battery post;
a clamping portion including a pair of elastic clamping members integrally extending from both ends of the pressing portion and to which a clamping bolt and a clamping nut are fastened through fastening apertures of the elastic clamping members; and
a burring that protrudes toward the first elastic clamping member is formed around a fastening aperture of the second elastic clamping member facing the first elastic clamping member of the pair of elastic clamping members.

2. The battery terminal of claim 1, wherein on the inner side of the burring, a tapered portion of which the inner diameter decreases downward from the end of the burring is formed at the end portion from which the clamping bolt is inserted, to prevent the threads of the clamping bolt from being locked and interfered.

3. The battery terminal of claim 1, wherein the surfaces of the parts of the terminal which include the clamping portion and the pressing portion are plated with a silicon-zinc (Sn—Zn) alloy and chromate treatment is performed on the surfaces as surface treatment to prevent corrosion and cracks due to stress.

4. The battery terminal of claim 1, wherein the first elastic clamping member is the elastic clamping member where the clamping bolt is inserted and the second elastic clamping member is the elastic clamping member where the clamping nut is fastened.

5. The battery terminal of claim 4, wherein a first wing that bends toward the head of the clamping bolt is formed along a side of the first elastic clamping member to restrict rotation of the clamping bolt.

6. The battery terminal of claim 5, wherein a second wing that bends along the side opposite to the first wing is formed at the first elastic clamping member to prevent deformation of the clamping portion.

7. The battery terminal of claim 5, wherein a third wing that bends toward the second elastic clamping member along the end of the first elastic clamping member is formed to maintain the gap between the first elastic clamping member and the second elastic clamping member, when coming in contact with the corresponding portion of the end of the second elastic clamping member.

8. The battery terminal of claim 1, wherein fourth wings that bend to restrict the rotation of a washer between the clamping nut and the second elastic clamping member are formed along both sides of the second elastic clamping member.

9. The battery terminal of claim 1, wherein protrusions or serration grooves are formed circumferentially around the inner side of the pressing portion.
